(19) United States
(12) Patent Application Publication
(10) Pub. No.: US 2026/0369500 A1
(43) Pub. Date: Nov. 19, 2026

(54) RELAY

(71) Applicant: Xiamen Hongfa Electric Power Controls Co., Ltd., Xiamen, Fujian (CN)

(72) Inventors: Liji SU, Xiamen, Fujian (CN); Wenguang DAI, Xiamen, Fujian (CN); Meng WANG, Xiamen, Fujian (CN)

(73) Assignee: Xiamen Hongfa Electric Power Controls Co., Ltd., Xiamen, Fujian (CN)

(21) Appl. No.: 19/121,077

(22) PCT Filed: Oct. 8, 2023
(86) PCT No.: PCT/CN2023/123423

§ 371 Date: Apr. 17, 2025

(30) Foreign Application Priority Data
Oct. 12, 2022 (CN) 202211249001.0

(51) Int. Cl. H01H 50/16; H01H 50/14; H01H 50/54

(52) U.S. Cl. CPC H01H 50/16; H01H 50/14; H01H 50/546

(57) ABSTRACT

A relay includes a contact container having a contact chamber; a pair of static contact leading-out terminals; a first magnetizer disposed within the contact chamber and fixed relative to the contact container; a push rod assembly including a push rod movable relative to the contact container and a support seat disposed at one axial end of the push rod; a movable contact assembly movable relative to the support seat, including a movable contact piece and a second magnetizer, and along the axial direction of the push rod, the first and second magnetizers are located at two opposite sides of the movable contact piece, the first and second magnetizers form a first magnetic circuit ; and a third magnetizer connected to the support seat movably disposed within the contact chamber the first and third magnetizer form a second magnetic circuit.

### CROSS-REFERENCE

This disclosure claims priority to Chinese patent application No. 202211249001.0 filed on Oct. 12, 2022, the entire contents of which are incorporated herein by reference.

### TECHNICAL FIELD

The embodiment of present disclosure relates to the technical field of relay, and more specifically, to a High-voltage DC relay.

### BACKGROUND

A relay is an electronic control device that consists of a control system (also known as the input circuit) and a controlled system (also known as the output circuit). It is commonly used in automatic control circuits. Essentially, a relay functions as an “automatic switch” that uses a smaller current to control a larger current. As such, it plays roles in automatic regulation, safety protection, and circuit switching within electrical systems.

High-voltage DC relays are a type of relay. In order to solve the problem that the contact of high voltage DC relay bounces off because of the electric repulsion generated by short circuit current, related technologies typically employ an anti-short-circuit ring electromagnetic structure. Based on the placement of the upper yoke iron, these structures are further categorized into follow-up type and fixed type. Specifically, the follow-up type structure refers that the upper yoke iron is installed on the movable component of the relay, while the fixed type structure refers that the upper yoke iron is installed in a fixed position other than the movable component. However, although the fixed-type anti-short-circuit structure has strong anti-short-circuit capability, its separating capacity is weakened due to the negative correlation between anti-short-circuit capability and separating capacity. On the other hand, the follow-up type anti-short-circuit structure is influenced by the holding force of the movable iron core. When the short-circuit current is high, the iron core will break off, which will lead to the disconnection of contacts, and to increase the holding force of the moving iron core, it is necessary to increase the coil, which is contrary to the small size and light weight.

### SUMMARY

The embodiments of the present disclosure provide a relay that takes into account both short-circuit withstand capability and limit separating capacity.

In an aspact of present disclosure, a relay including:
a contact container having a contact chamber;
a pair of static contact leading-out terminals connected to the contact container, with at least a portion of the static contact leading-out terminals located within the contact chamber;
a first magnetizer disposed within the contact chamber and fixed relative to the contact container;
a push rod assembly including a push rod and a support seat, wherein the push rod is movable relative to the contact container along an axial direction of the push rod, and the support seat is disposed at one axial end of the push rod and extends at least partially into the contact chamber;
a movable contact assembly movable relative to the support seat along the axial direction of the push rod, the movable contact assembly including a movable contact piece and a second magnetizer, wherein both ends of the movable contact piece are configured to contact with or separate from the pair of static contact leading-out terminals, and along the axial direction of the push rod, the first magnetizer is located at a side of the movable contact piece facing the static contact leading-out terminals, while the second magnetizer is fixedly disposed to a side of the movable contact piece facing away from the first magnetizer, the second magnetizer is configured to form a first magnetic circuit with the first magnetizer; and
a third magnetizer connected to the support seat and located at the side of the movable contact piece facing away from the first magnetizer, the third magnetizer is movably disposed within the contact chamber along the axial direction of the push rod and configured to form a second magnetic circuit with the first magnetizer;
wherein, during a process of the movable contact piece separating from the static contact leading-out terminals, the third magnetizer moves away from the first magnetizer prior to the second magnetizer.

According to some embodiments of the present disclosure, the movable contact assembly is movable relative to the support seat between a first position closer to the static contact leading-out terminals and a second position farther from the static contact leading-out terminals along the axial direction of the push rod;
the relay further includes a first elastic member disposed between the support seat and the movable contact assembly, configured to apply an elastic force to the movable contact assembly toward the first position.

According to some embodiments of the present disclosure, in the second position, a magnetic pole surface of the second magnetizer facing the first magnetizer is flush with a magnetic pole surface of the third magnetizer facing the first magnetizer.

According to some embodiments of the present disclosure, during a process of the movable contact piece separating from the static contact leading-out terminals, and when the movable contact assembly is in the first position relative to the support seat, a magnetic gap between the third magnetizer and the first magnetizer is greater than a magnetic gap between the second magnetizer and the first magnetizer.

According to some embodiments of the present disclosure, the movable contact assembly is movably connected to the support seat through a limiting structure, the limiting structure is configured to restrict a movement of the movable contact assembly relative to the support seat between the first position and the second position; the limiting structure includes:
a limiting groove provided on one of the movable contact assembly and the support seat, the limiting groove extending along the axial direction of the push rod, with a stopping wall provided at one end of the groove wall closer to the static contact leading-out terminals; and
a limiting block provided on another one of the movable contact assembly and the support seat, the limiting block is slidably fitted with the limiting groove, and in the first position, the stopping wall abuts against the limiting block.

According to some embodiments of the present disclosure, in the first position, a first gap exists between the limiting block and a side wall of the limiting groove;
in the second position, a second gap exists between the limiting block and the side wall of the limiting groove;
the first gap is smaller than the second gap.

According to some embodiments of the present disclosure, the limiting block is provided on the second magnetizer, and the limiting groove is provided on the support seat.

According to some embodiments of the present disclosure, the support seat includes:
a base connected to an end of the push rod along the axial direction of the push rod, with one end of the first elastic member abutting against the base and another end abutting against the movable contact assembly; and
a bracket connected to the base, the limiting groove is provided on the bracket.

According to some embodiments of the present disclosure, the third magnetizer has a through-hole, the first elastic member passes through the through-hole.

According to some embodiments of the present disclosure, a thickness of the second magnetizer is equal to a thickness of the third magnetizer.

According to some embodiments of the present disclosure, the contact container further includes a pair of first through-holes and a second through-hole, both the first through-holes and the second through-hole are in communication with the contact chamber; the pair of static contact leading-out terminals are respectively passed through the pair of first through-holes;
the relay further includes a connector passed through the second through-hole, the connector includes a first end and a second end, the first end is connected to the contact container, and the second end is connected to the first magnetizer.

According to some embodiments of the present disclosure, the contact container includes:
a yoke plate; and
an insulating cover connected to the yoke plate;
wherein the first through-holes and the second through-hole are provided on the insulating cover, and the first end of the connector is connected to an outer wall surface of the insulating cover.

According to some embodiments of the present disclosure, the insulating cover includes a ceramic cover and a frame member, the ceramic cover includes the top wall and the side wall, another end of the side wall is connected to the yoke plate the frame member;
on an outer wall surface of the top wall, a first metallization layer is provided around a periphery of the first through-hole, and a second metallization layer is provided around a periphery of the second through-hole;
the static contact leading-out terminals are welded to the top wall through the first metallization layer, and the first end of the connector is welded to the top wall through the second metallization layer.

According to some embodiments of the present disclosure, the first magnetizer is spaced apart from an inner wall surface of the top wall.

According to some embodiments of the present disclosure, the first magnetizer includes a plurality of magnetic sheets stacked with each other, and the plurality of magnetic sheets are connected to a second end of the connector.

According to some embodiments of the present disclosure, the contact container includes:
a yoke plate; and
an insulating cover connected to the yoke plate;
the relay further includes a fixing frame disposed within the contact chamber and fixedly connected to the yoke plate, the first magnetizer is fixedly connected to the fixing frame.

At least one embodiment of the above disclosure has the following advantages or beneficial effects:

In the relay of the embodiment of the present disclosure, the second magnetizer and the third magnetizer are located at a side of the movable contact piece away from the first magnetizer. When a short-circuit current flows, both the first magnetizer and the second magnetizer, as well as the third magnetizer and the first magnetizer, form an anti-short-circuit structure, effectively enhancing the upper limit of the anti-short circuit capability. Moreover, during the process of the movable contact piece separating from the static contact leading-out terminals, the third magnetizer moves away from the first magnetizer prior to the second magnetizer. This staged separating method is more conducive to completing the separating process. Therefore, the relay of the embodiment of the present disclosure not only ensures short-circuit withstand capability but also meets the requirements for limit separating capacity.

### BRIEF DESCRIPTION OF THE DRAWINGS

The above and other features and advantages of the present disclosure will become more apparent by describing in detail exemplary embodiments thereof with reference to the accompanying drawings.

FIG. 1 shows a perspective schematic diagram of the relay according to an embodiment of the present disclosure, with the housing, the electromagnetic unit, and arc extinguishing unit removed.

FIG. 2 shows a schematic diagram of FIG. 1 with the ceramic cover and frame member removed.

FIG. 3 shows a top view schematic diagram of FIG. 1.

FIG. 4 shows a cross-sectional view taken along line A-A in FIG. 3.

FIG. 5 shows an exploded schematic diagram of FIG. 1.

FIG. 6 shows a cross-sectional view taken along line A-A in FIG. 3, with the ceramic cover and frame member removed and the overtravel completed.

FIG. 7 shows a cross-sectional view taken along line B-B in FIG. 3, with the ceramic cover and frame member removed and the overtravel completed.

FIG. 8 shows a partial enlarged view of X portion in FIG. 7.

FIG. 9 shows a side view of FIG. 2, with the overtravel completed.

FIG. 10 shows a cross-sectional view taken along line A-A in FIG. 3, with the ceramic cover and frame member removed and the third magnetizer moving prior to the second magnetizer.

FIG. 11 shows a cross-sectional view taken along line B-B in FIG. 3, with the ceramic cover and frame member removed and the third magnetizer moving prior to the second magnetizer.

FIG. 12 shows a partial enlarged view of Y portion in FIG. 11.

FIG. 13 shows a side view of FIG. 2, with the third magnetizer moving prior to the second magnetizer.

FIG. 14 shows a partial enlarged view of M portion in FIG. 2.

FIG. 15 shows a schematic diagram of the first magnetizer fixedly connected to the fixing frame.

FIG. 16 shows an exploded schematic diagram of the relay according to an embodiment of the present disclosure.

### REFERENCE NUMERALS

10. contact container; 101. contact chamber; 102. first through-hole; 103. second through-hole; 11a. insulating cover; 11. ceramic cover; 111. top wall; 112. side wall; 113. first metallization layer; 114. second metallization layer; 12. frame member; 13. yoke plate; 131. third through-hole; 20. static contact leading-out terminal; 30. connector; 31. first end of the connector; 32. second end of the connector; 40. first magnetizer; 410. magnetic piece; 411. opening; 50. push rod assembly; 51. push rod; 52. support seat; 521. base; 522. bracket; 523. guide hole; 53. movable contact assembly; 54. movable contact piece; 55. second magnetizer; 551. opening; 552. first magnetic pole surface; 56. first elastic member; 57. second elastic member; 60. third magnetizer; 610. through-hole; 620. protrusion; 630. second magnetic pole surface; 70. fixed frame; 80. limiting structure; 810. limiting groove; 811. stop wall; 820. limiting block; 1100. housing; 1110. first housing; 1120. second housing; 1130. exposed hole; 1200. electromagnet unit; 1210. bobbin; 1220. coil; 1240. movable core; 1250. reset member; 1300. arc extinguishing unit; 1310. arc extinguishing magnet; 1320. yoke clip; 1400. sealing unit; 1410. metal cover; D1. movement direction; D2. length direction; D3. width direction.

### DETAILED DESCRIPTION

Now, exemplary embodiments will be described more comprehensively with reference to the accompanying drawings. However, the exemplary embodiments can be implemented in various forms and should not be construed as limited to the embodiments set forth herein. On the contrary, these embodiments are provided to make the present disclosure thorough and complete, and to fully convey the concepts of the exemplary embodiments to those skilled in the art. In the drawings, the same reference numerals denote the same or similar structures, and thus their detailed descriptions will be omitted.

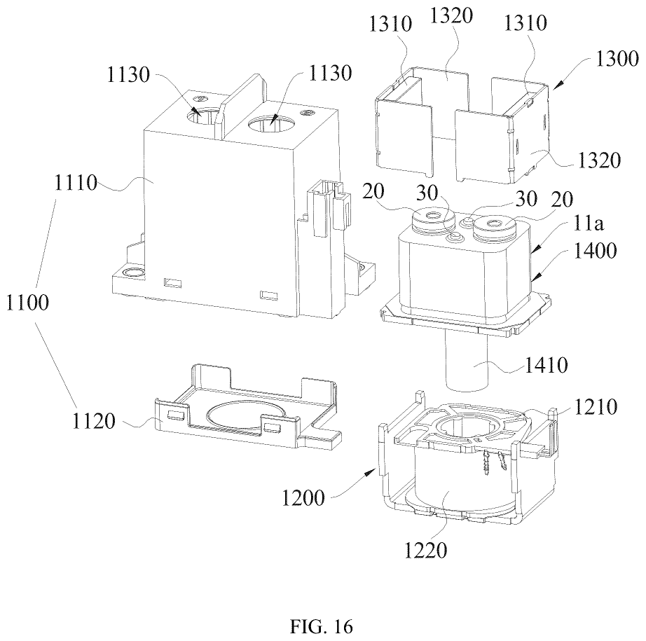

As shown in FIG. 16, FIG. 16 illustrates an exploded schematic diagram of a relay according to an embodiment of the present disclosure. The relay includes a housing 1100, an electromagnet unit 1200, an arc extinguishing unit 1300, and a sealing unit 1400. The sealing unit 1400 is disposed inside the housing 1100, and the top of the static contact leading-out terminal of the sealing unit 1400 is exposed on the outer surface of the housing 1100 through an exposed hole 1130 of the housing 1100. The electromagnet unit 1200 and the arc extinguishing unit 1300 are both arranged inside the housing 1100.

As an example, the housing 1100 includes a first housing 1110 and a second housing 1120, which are clamped together to form a chamber for accommodating the electromagnet unit 1200, the arc extinguishing unit 1300, and the sealing unit 1400.

The arc extinguishing unit 1300 is used to extinguish arcs generated between the static contact leading-out terminal of the sealing unit 1400 and the movable contact piece.

As an example, the arc extinguishing unit 1300 includes two arc extinguishing magnets 1310. The arc extinguishing magnets 1310 may be permanent magnets, and each arc extinguishing magnet 1310 may be generally rectangular. The two arc extinguishing magnets 1310 are respectively arranged on both sides of the sealing unit 1400 and are oppositely positioned along the length direction D2 of the movable contact piece.

By arranging two oppositely positioned arc extinguishing magnets 1310, a magnetic field can be formed around the static contact leading-out terminal and the movable contact piece. Therefore, arcs generated between the static contact leading-out terminal and the movable contact piece are stretched in opposite directions under the action of the magnetic field, achieving arc extinguishing.

The arc extinguishing unit 1300 further includes two yoke clips 1320, which correspond in position to the two arc extinguishing magnets 1310. Moreover, the two yoke clips 1320 surround the sealing unit 1400 and the two arc extinguishing magnets 1310. The design of the yoke clips 1320 surrounding the arc extinguishing magnets 1310 prevents the magnetic field generated by the arc extinguishing magnets 1310 from diffusing outward, thereby ensuring the arc extinguishing effect. The yoke clips 1320 are made of soft magnetic materials, which may include but are not limited to iron, cobalt, nickel, and their alloys.

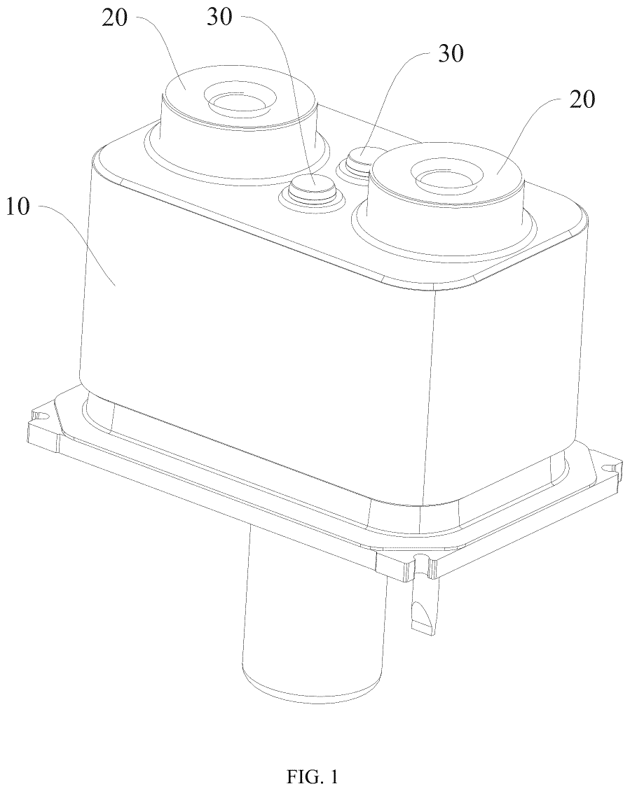

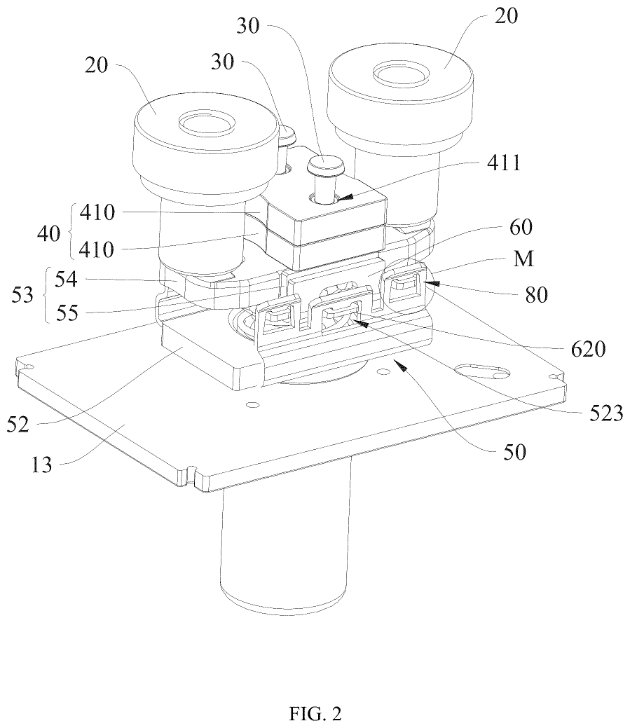

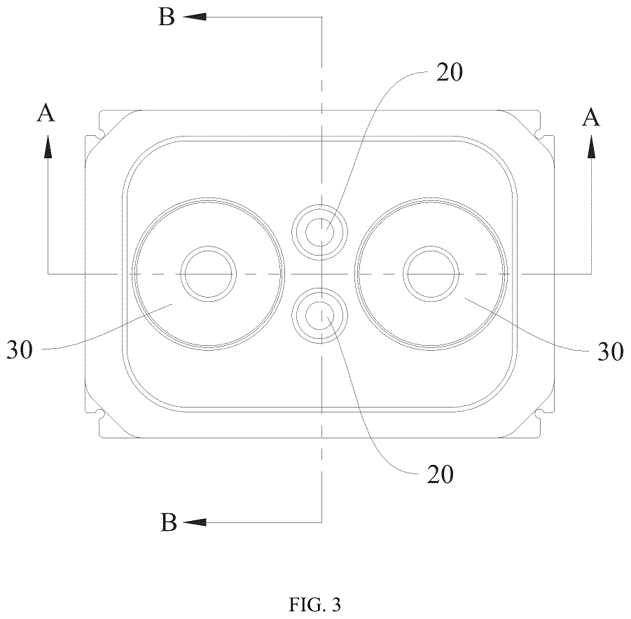

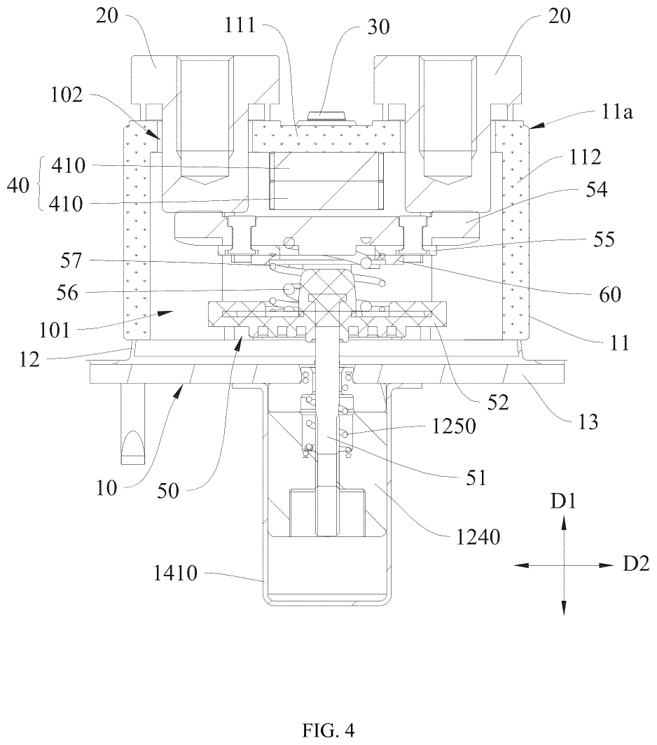

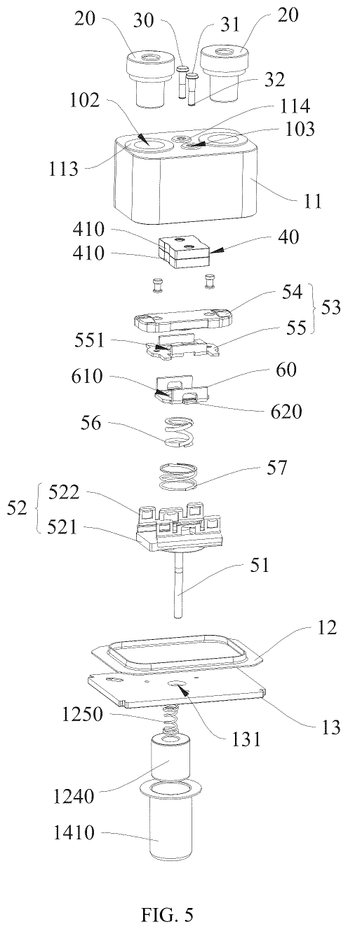

As shown in FIG. 1 to FIG. 5, FIG. 1 illustrates a perspective schematic diagram of the relay according to an embodiment of the present disclosure, with the housing, the electromagnet unit, and arc extinguishing unit removed. FIG. 2 illustrates a schematic diagram of FIG. 1 with the ceramic cover and frame member removed. FIG. 3 illustrates a top view of FIG. 1. FIG. 4 illustrates a cross-sectional view taken along line A-A in FIG. 3. FIG. 5 illustrates an exploded schematic diagram of FIG. 1.

The relay of the embodiment of the present disclosure includes a contact container 10, a pair of static contact leading-out terminals 20, a first magnetizer 40, a push rod assembly 50, a movable contact assembly 53, and a third magnetizer 60.

It is to be understood that the terms “comprising” and “having” and any variations thereof in the embodiments of the present disclosure are intended to cover non-exclusive inclusion. For example, a process, method, system, product, or device that includes a series of steps or units is not limited to the listed steps or units but may optionally include steps or units not listed, or may optionally include other steps or components inherent to such processes, methods, products, or devices.

The contact container 10 has a contact chamber 101 inside. The contact container 10 may include an insulating cover 11a and a yoke plate 13. The insulating cover 11a covers one side surface of the yoke plate 13, and the insulating cover 11a and the yoke plate 13 together enclose the contact chamber 101.

The insulating cover 11a includes a ceramic cover 11 and a frame member 12. The ceramic cover 11 is connected to the yoke plate 13 through the frame member 12. The frame member 12 may be a ring-shaped metal component, such as an iron-nickel alloy, with one end connected to the edge of the opening of the ceramic cover 11, for example, by laser welding, brazing, resistance welding, or adhesive bonding. The other end of the frame member 12 is connected to the yoke plate 13, also by laser welding, brazing, resistance welding, or adhesive bonding. The frame member 12 between the ceramic cover 11 and the yoke plate 13 facilitates their connection.

The ceramic cover 11 includes a top wall 111 and a side wall 112. One end of the side wall 112 is connected around the periphery of the top wall 111, and the other end of the side wall 112 is connected to the yoke plate 13 through the frame member 12. In this embodiment, the other end of the side wall 112 is connected to the yoke plate 13 through the frame member 12.

The contact container 10 further has a pair of first through-holes 102 and a second through-hole 103, both communicating with the contact chamber 101. The first through-holes 102 are used for the static contact leading-out terminals 20 to pass through, and the second through-hole 103 is used for a connector 30 to pass through.

As an example, the first through-holes 102 and the second through-hole 103 are both formed in the top wall 111 of the ceramic cover 11. The second through-hole 103 may be located between the two first through-holes 102, meaning the connector 30 is located between the pair of static contact leading-out terminals 20.

The number of second through-holes 103 may be two, for two connectors 30 to pass through, but this is not limiting.

The pair of static contact leading-out terminals 20 are connected to the contact container 10, with at least part of each static contact leading-out terminal 20 located inside the contact chamber 101. One of the pair of static contact leading-out terminals 20 serves as the current input terminal, and the other serves as the current output terminal.

The pair of static contact leading-out terminals 20 are respectively inserted through the pair of first through-holes 102 and connected to the top wall 111 of the ceramic cover 11, for example, by welding.

The bottom of each static contact leading-out terminal 20 serves as a static contact, which may be integrally or separately formed at the bottom of the static contact leading-out terminal 20.

The first magnetizer 40 is disposed inside the contact chamber 101 and is fixed relative to the contact container 10.

The push rod assembly 50 is movably connected to the contact container 10 along the movement direction D1. The push rod assembly 50 includes a push rod 51 and a support seat 52. The push rod 51 is movable relative to the contact container 10 along its axial direction, and the support seat 52 is fixed at one end of the push rod 51 along its axial direction and extends at least partially into the contact chamber 101.

The yoke plate 13 has a third through-hole 131, which penetrates the two opposite sides of the yoke plate 13 along its thickness direction and communicates with the contact chamber 101 of the contact container 10. The push rod 51 is movably inserted through the third through-hole 131 along its axial direction.

The movable contact assembly 53 is movable relative to the support seat 52 along the axial direction of the push rod 51. The movable contact assembly 53 includes a movable contact piece 54 and a second magnetizer 55. Along the axial direction of the push rod 51, the second magnetizer 55 is fixedly disposed to the side of the movable contact piece 54 facing away from the first magnetizer 40. That is, along the thickness direction of the movable contact piece 54, the first magnetizer 40 is located at one side of the movable contact piece 54, and the second magnetizer 55 is located at the other side. Thus, when the movable contact piece 54 contacts the static contact leading-out terminals 20 and flows through the overcurrent, a first magnetic circuit can be formed between the first magnetizer 40 and the second magnetizer 55, generating a magnetic attractive force between them.

As an example, the second magnetizer 55 and the movable contact piece 54 may be fixed by riveting, but this is not limiting.

The two ends of the movable contact piece 54 are used to contact the bottoms of the pair of static contact leading-out terminals 20, achieving contact closure. The two ends of the movable contact piece 54 along its length direction D2 serve as movable contacts. The movable contacts at the two ends of the movable contact piece 54 may protrude from the rest of the movable contact piece 54 or be flush with it.

It is to be understood that the movable contacts may be integrally or separately formed at the two ends of the movable contact piece 54 along its length direction D2.

The third magnetizer 60 is connected to the support seat 52 and is located at the side of the movable contact piece 54 facing away from the first magnetizer 40. It is movably disposed inside the contact chamber 101 along the axial direction of the push rod 51. A second magnetic circuit can be formed between the third magnetizer 60 and the first magnetizer 40.

That is, along the axial direction of the push rod 51, the first magnetizer 40 is located at one side of the movable contact piece 54, and the second magnetizer 55 and the third magnetizer 60 are located at the other side. When the movable contact piece 54 contacts the static contact leading-out terminals 20 and carries current, a second magnetic circuit can be formed between the first magnetizer 40 and the third magnetizer 60, generating a magnetic attractive force between them.

It is to be understood that the first magnetizer 40, the second magnetizer 55, and the third magnetizer 60 may all be made of materials such as iron, cobalt, nickel, or their alloys.

In one embodiment, the first magnetizer 40 may be linear shape, and the second magnetizer 55 and the third magnetizer 60 may be U-shaped, but this is not limiting.

It is to be understood that the first magnetizer 40, the second magnetizer 55, and the third magnetizer 60 may all be designed to include multiple stacked magnetic pieces as needed.

In this embodiment, along the width direction D3 of the movable contact piece 54, the second magnetizer 55 surrounds the bottom surface and two opposite side surfaces of the movable contact piece 54. The third magnetizer 60 is located at the side of the second magnetizer 55 facing away from the movable contact piece 54 and may surround the bottom surface and two opposite side surfaces of the second magnetizer 55, but this is not limiting.

During the process of the movable contact piece 54 separating form the static contact leading-out terminals 20, the third magnetizer 60 moves away from the first magnetizer 40 before the second magnetizer 55 does.

The movable contact assembly 53 is movable relative to the support seat 52 along the axial direction of the push rod 51 between a first position closer to the static contact leading-out terminals 20 and a second position farther away from the static contact leading-out terminals 20. The relay further includes a first elastic member 56, which is disposed between the support seat 52 and the movable contact assembly 53 and applies an elastic force to the movable contact assembly 53 toward the first position.

It should be noted that the “first position” and “second position” in the statement “the movable contact assembly 53 is movable relative to the support seat 52 along the axial direction of the push rod 51 between the first position and the second position” refer to the relative positions of the movable contact assembly 53 and the support seat 52.

Specifically, when the electromagnet unit 1200 is energized, it drives the push rod 51, the support seat 52, and the movable contact assembly 53 to move together toward the static contact leading-out terminals 20. When the movable contact assembly 53 contacts the static contact leading-out terminals 20, the movable contact assembly 53 is stopped by the static contact leading-out terminals 20, while the push rod 51 and the support seat 52 continue to move upward until the overtravel process is completed. During the overtravel process, relative movement occurs between the movable contact assembly 53 and the support seat 52.

During the overtravel process, If the movable contact assembly 53 is defined as stationary, the support seat 52 moves upward relative to the movable contact assembly 53. Conversely, if the support seat 52 is defined as stationary, the movable contact assembly 53 moves downward relative to the support seat 52.

Thus, when the movable contact assembly 53 is separated from the static contact leading-out terminals 20 or has just contacted the static contact leading-out terminals 20, the movable contact assembly 53 is in the first position relative to the support seat 52, meaning the movable contact assembly 53 is closer to the static contact leading-out terminals 20 relative to the support seat 52. During the overtravel process, the movable contact assembly 53 moves downward relative to the support seat 52, i.e., the movable contact assembly 53 moves away from the static contact leading-out terminals 20 relative to the support seat 52, until the movable contact assembly 53 reaches the second position relative to the support seat 52. When the movable contact assembly 53 moves to the second position relative to the support seat 52, the overtravel is completed. At this point, the compression of the first elastic member 56 reaches its maximum value.

From this, it can be seen that when the movable contact assembly 53 is in the first position relative to the support seat 52, it can be considered that the movable contact assembly 53 is either separated from the static contact leading-out terminals 20 or has just contacted the static contact leading-out terminals 20. When the movable contact assembly 53 is in the second position relative to the support seat 52, the overtravel is completed.

When the electromagnet unit 1200 is de-energized, it drives the push rod 51 and the support seat 52 to move together away from the static contact leading-out terminals 20. Before the overtravel is completed, the movable contact assembly 53 remains in contact with the static contact leading-out terminals 20, and the movable contact assembly 53 begins to move from the second position to the first position relative to the support seat 52. When the overtravel is completed, the movable contact assembly 53 begins to separate from the static contact leading-out terminals 20 under the action of the support seat 52. At the same time, the movable contact assembly 53 moves from the second position to the first position relative to the support seat 52.

As an example, the first elastic member 56 may be a spring, but this is not limiting.

In one embodiment, the second magnetizer 55 has an opening 551, which penetrates the two opposite side surfaces of the second magnetizer 55 along its thickness direction. Through this opening 551, part of the bottom surface of the movable contact piece 54 is exposed. One end of the first elastic member 56 abuts against the support seat 52, and the other end passes through the opening 551 and abuts against the bottom surface of the movable contact piece 54 of the movable contact assembly 53.

As shown in FIG. 5, the third magnetizer 60 has a through-hole 610, and the first elastic member 56 passes through the through-hole 610.

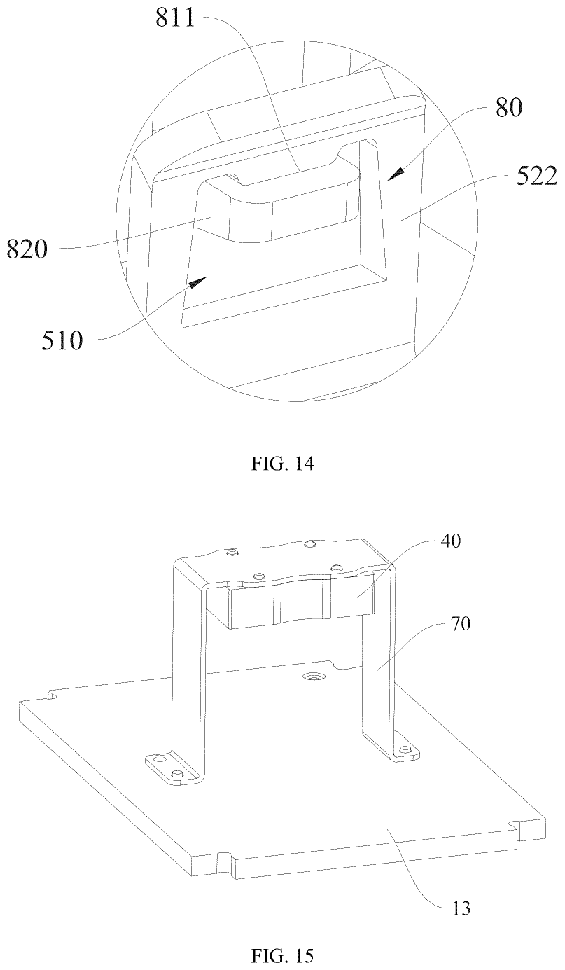

As shown in FIG. 2 and FIG. 14, the movable contact assembly 53 and the support seat 52 are movably connected through a limiting structure 80, which is used to limit the movement of the movable contact assembly 53 relative to the support seat 52 between the first position and the second position.

The limiting structure 80 includes a limiting groove 810 and a limiting block 820. The limiting groove 810 is formed on one of the movable contact assembly 53 and the support seat 52, and the limiting groove 810 extends along the axial direction of the push rod 51. The limiting block 820 is formed on the other of the movable contact assembly 53 and the support seat 52, and the limiting block 820 is slidably fitted with the limiting groove 810.

In this embodiment, the limiting block 820 is formed on the movable contact assembly 53, and the limiting groove 810 is formed on the support seat 52. Specifically, the limiting block 820 may be formed on the second magnetizer 55 or the movable contact piece 54 of the movable contact assembly 53.

Of course, in other implementations, the limiting block 820 may also be formed on the support seat 52, and the limiting groove 810 may be formed on the movable contact assembly 53.

When the movable contact assembly 53 is in the first position relative to the support seat 52, there is a first gap between the limiting block 820 and the side wall of the limiting groove 810. When the movable contact assembly 53 is in the second position relative to the support seat 52, there is a second gap between the limiting block 820 and the side wall of the limiting groove 810. The first gap is smaller than the second gap.

Since the first gap is smaller than the second gap, the limiting groove 810 has a structure that one end is big and the other end is small. Therefore, during the movement of the movable contact assembly 53 from the first position to the second position relative to the support seat 52, the gap between the limiting block 820 and the side wall of the limiting groove 810 increases, preventing friction and jamming between the limiting block 820 and the groove wall of the limiting groove 810.

The groove wall of the limiting groove 810 near the static contact leading-out terminals 20 has a stop wall 811. When the movable contact assembly 53 moves to the first position, the stop wall 811 stops the limiting block 820.

The support seat 52 includes a base 521 and a bracket 522. The base 521 is connected to one end of the push rod 51 along its axial direction, and the bracket 522 is connected to the base 521. One end of the first elastic member 56 abuts against the base 521, and the other end abuts against the movable contact assembly 53.

In one embodiment, the bracket 522 may be provided with the limiting block 820 or the limiting groove 810.

As shown in FIG. 2 and FIG. 5, the third magnetizer 60 has a protrusion 620, and the support seat 52 has a guide hole 523, which extends along the axial direction of the push rod 51. The protrusion 620 extends into the guide hole 523.

The relay further includes a second elastic member 57, which is disposed between the third magnetizer 60 and the support seat 52 and is used to apply an elastic force to the third magnetizer 60 toward the movable contact assembly 53.

As an example, the second elastic member 57 may be a spring, with one end abutting against the base 521 and the other end abutting against the third magnetizer 60, ensuring that the protrusion 620 of the third magnetizer 60 always abuts against the upper edge of the guide hole 523.

Of course, in other implementations, the third magnetizer 60 and the support seat 52 may also be fixedly connected through a clamping structure. For example, the third magnetizer 60 is fixedly snapped to the bracket 522 of the support seat 52. When the push rod 51 drives the support seat 52 to move, the support seat 52 can drive the third magnetizer 60 to move together.

As shown in FIG. 5 and FIG. 16, the sealing unit 1400 further includes a metal cover 1410, which is connected to the side of the yoke plate 13 facing away from the insulating cover 11a. The metal cover 1410 covers the third through-hole 131 on the yoke plate 13. The metal cover 1410 and the yoke plate 13 together form a chamber for accommodating the static core and the movable core 1240 of the electromagnet unit 1200, which will be described in detail below.

The electromagnet unit 1200 includes a bobbin 1210, a coil 1220, a static core, a movable core 1240, and a reset member 1250. The bobbin 1210 is hollow and cylindrical and is made of an insulating material. The metal cover 1410 is inserted through the bobbin 1210. The coil 1220 is wound around the bobbin 1210. The static core is fixed inside the metal cover 1410, with part of the static core extending into the third through-hole 131. The static core has a through-hole that corresponds in position to the third through-hole 131, allowing the push rod 51 to pass through. The movable core 1240 is movably disposed inside the metal cover 1410 and is arranged opposite to the static core. The movable core 1240 is connected to the push rod 51 and is attracted by the static core when the coil 1220 is energized. The movable core 1240 and the push rod 51 may be connected by screwing, riveting, welding, or other methods.

The reset member 1250 is located inside the metal cover 1410 and is disposed between the static core and the movable core 1240. It is used to reset the movable core 1240 when the coil 1220 is de-energized. The reset member 1250 may be a spring and is sleeved over the push rod 51.

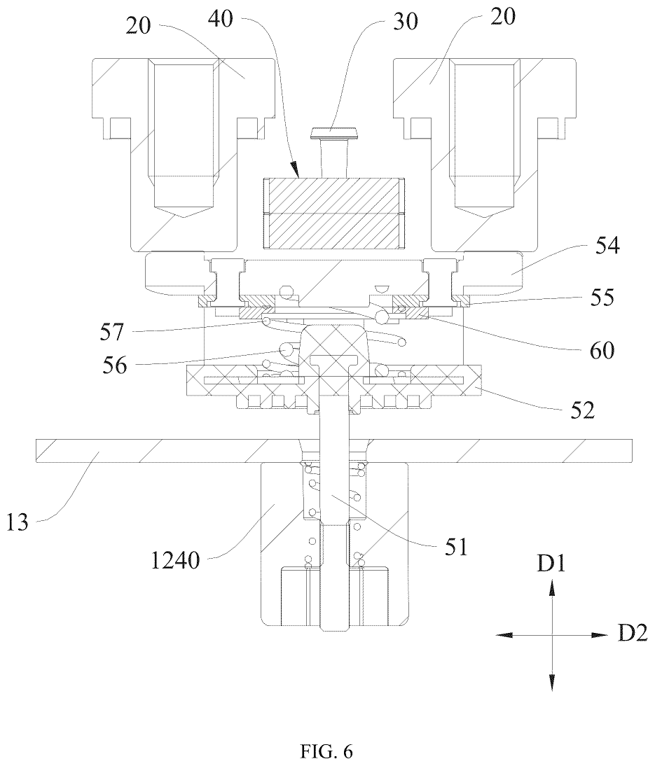

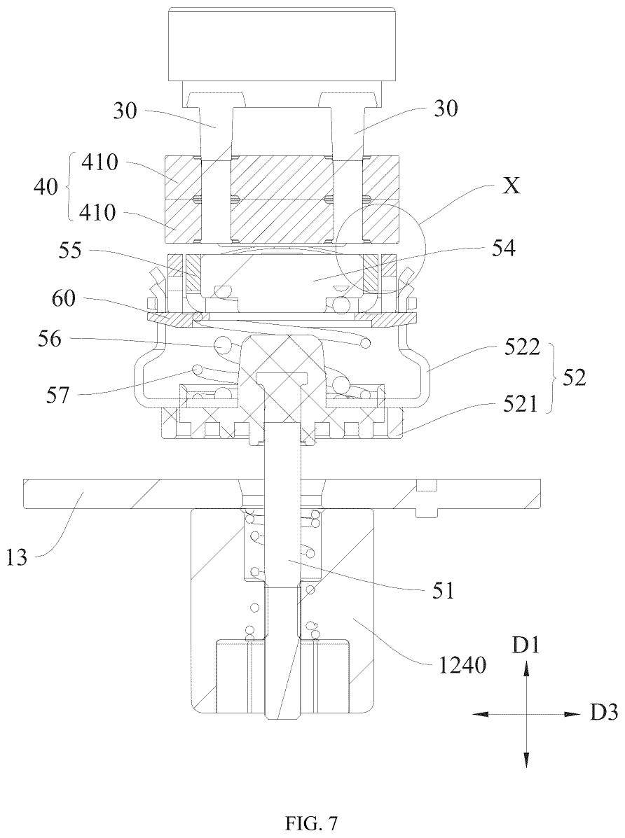

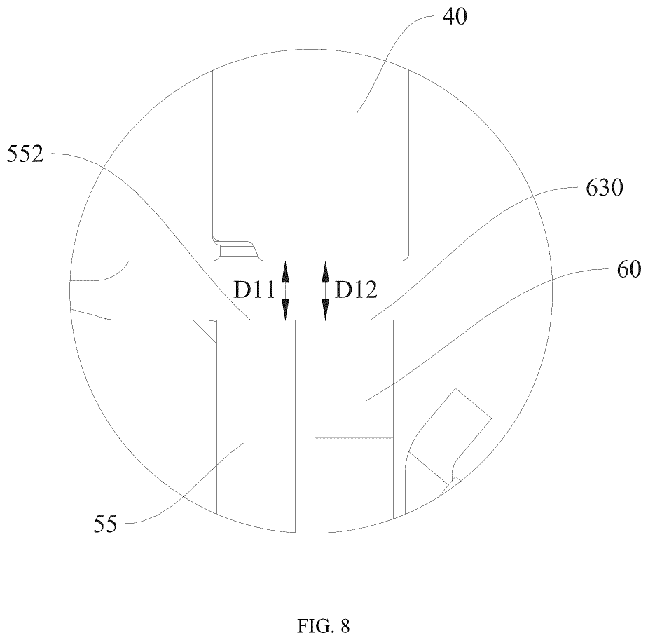

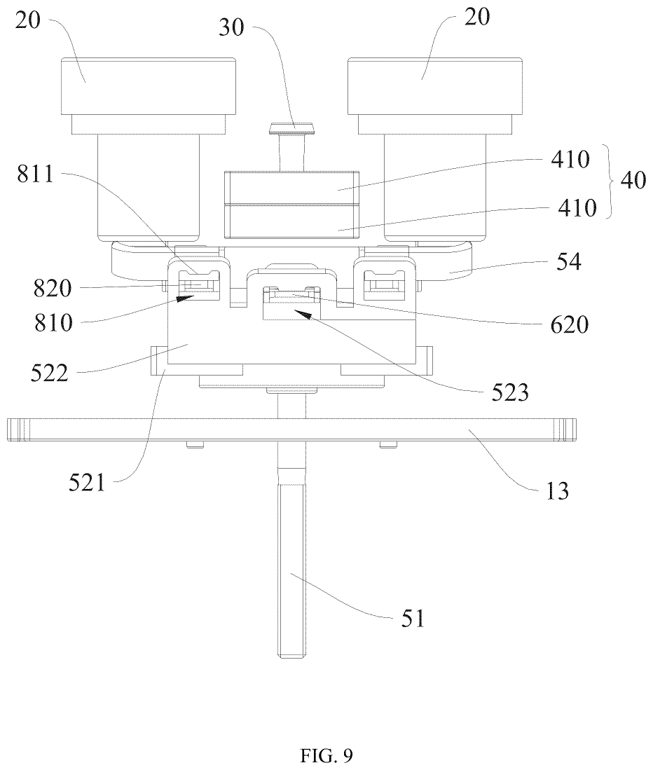

As shown in FIG. 6 to FIG. 9, FIG. 6 shows a cross-sectional view taken along line A-A in FIG. 3, with the ceramic cover and frame member removed and the overtravel completed. FIG. 7 shows a cross-sectional view taken along line B-B in FIG. 3, with the ceramic cover and frame member removed and the overtravel completed. FIG. 8 shows a partial enlarged view of the X portion in FIG. 7. FIG. 9 shows a side view of FIG. 2, with the overtravel completed.

It should be noted that FIG. 6 to FIG. 9 show the state after the overtravel is completed. In this state, the movable contact assembly 53 can be considered to be in the second position relative to the support seat 52.

A first magnetic circuit is formed between the first magnetizer 40 and the second magnetizer 55, generating a magnetic attractive force between them. A second magnetic circuit is formed between the third magnetizer 60 and the first magnetizer 40, generating a magnetic attractive force between them. Since the first magnetizer 40 is fixed relative to the contact container 10, a fixed anti-short-circuit structure is formed between the first magnetizer 40 and the second magnetizer 55, as well as between the third magnetizer 60 and the first magnetizer 40, when a short-circuit current flows. The holding force of the fixed anti-short-circuit structure is provided by the contact container 10. Under the condition of a constant coil drive, the relay of the embodiment of the present disclosure effectively increases the upper limit of anti-short-circuit current-carrying capacity. Thus, the magnetic attractive force of the first magnetizer 40 is distributed to the second magnetizer 55 and the third magnetizer 60.

As shown in FIG. 7 and FIG. 8, when the movable contact assembly 53 is in the second position relative to the support seat 52 (i.e., the overtravel is completed), the first magnetic pole surface 552 of the second magnetizer 55 facing the first magnetizer 40 is flush with the second magnetic pole surface 630 of the third magnetizer 60 facing the first magnetizer 40.

That is, the distance D11 between the first magnetic pole surface 552 and the first magnetizer 40 is equal to the distance D12 between the second magnetic pole surface 630 and the first magnetizer 40.

When the overtravel is completed, by designing the first magnetic pole surface 552 and the second magnetic pole surface 630 to be flush, the magnetic attractive force of the first magnetizer 40 is evenly distributed between the second magnetizer 55 and the third magnetizer 60, assuming other factors (such as current magnitude, magnetizer material/thickness) remain substantially the same.

Furthermore, the thickness of the second magnetizer 55 is equal to that of the third magnetizer 60. Of course, the thickness of the second magnetizer 55 and the third magnetizer 60 may also be unequal.

Of course, in other implementations, the first magnetic pole surface 552 and the second magnetic pole surface 630 may not be flush. For example, the first magnetic pole surface 552 may be higher or lower than the second magnetic pole surface 630.

As shown in FIG. 9, when the overtravel is completed, the movable contact assembly 53 is in the second position relative to the support seat 52, and the limiting block 820 is spaced apart from the stop wall 811 of the limiting groove 810.

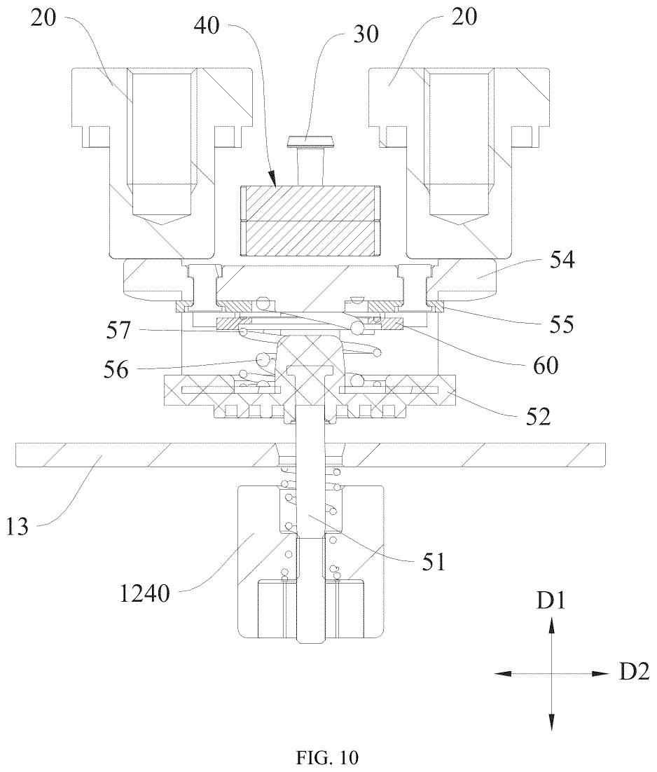

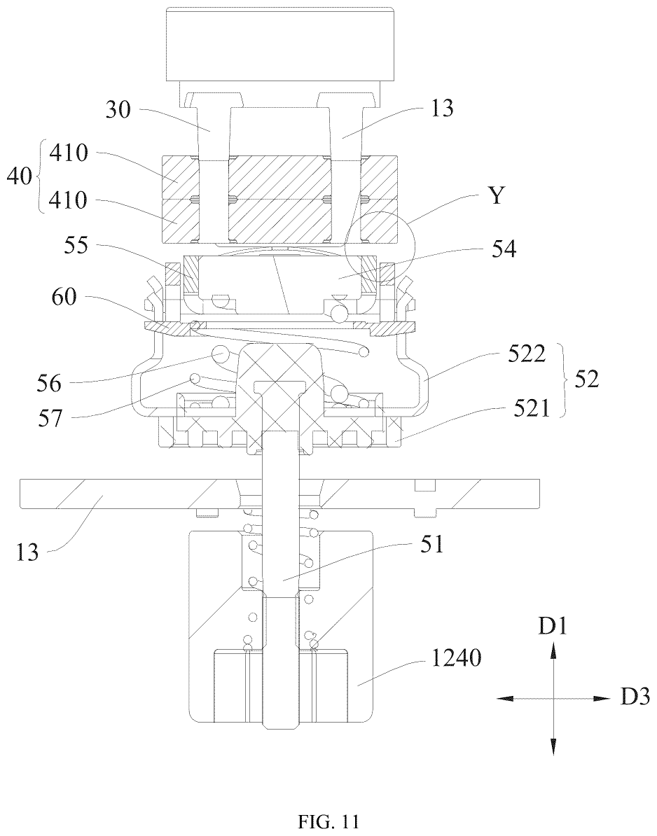

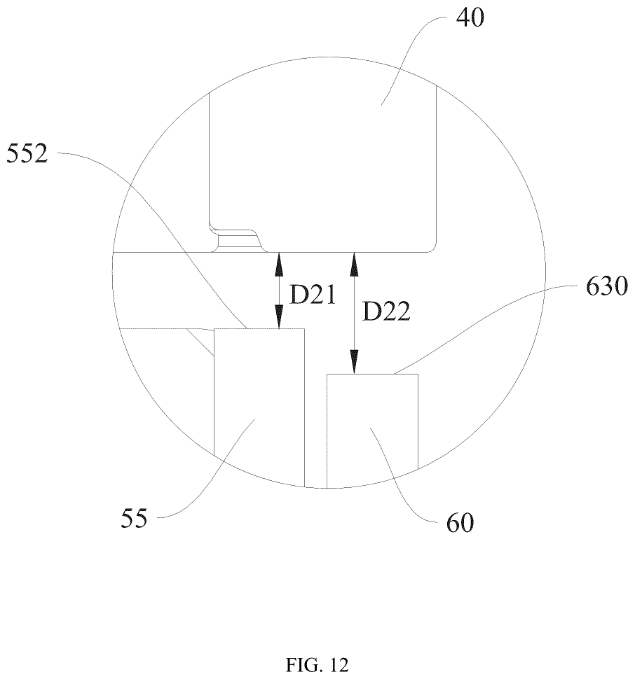

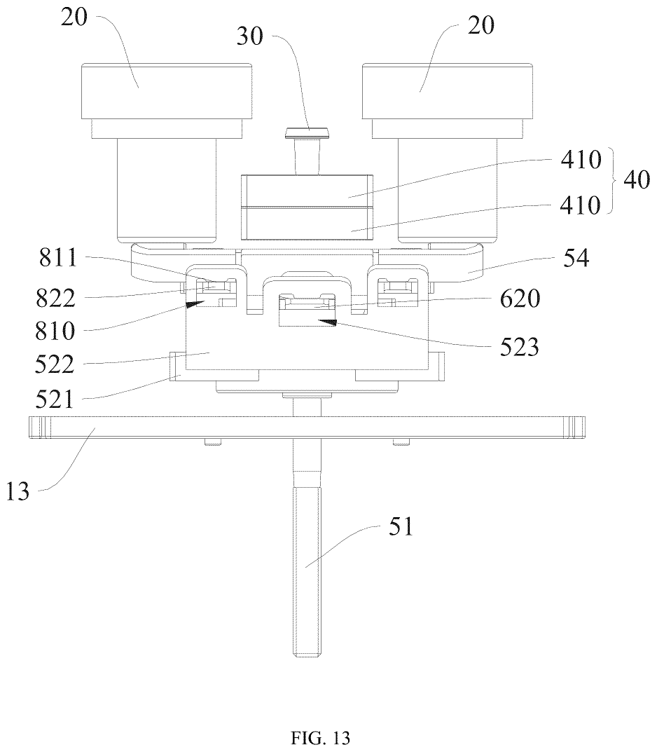

As shown in FIG. 10 to FIG. 13, FIG. 10 shows a cross-sectional view taken along line A-A in FIG. 3, with the ceramic cover and frame member removed and the third magnetizer moving before the second magnetizer. FIG. 11 shows a cross-sectional view taken along line B-B in FIG. 3, with the ceramic cover and frame member removed and the third magnetizer moving before the second magnetizer. FIG. 12 shows a partial enlarged view of the Y portion in FIG. 11. FIG. 13 shows a side view of FIG. 2, with the third magnetizer moving before the second magnetizer.

It should be noted that FIG. 10 to FIG. 13 show the state after the third magnetizer moves before the second magnetizer during the process of the movable contact piece 54 separating form the static contact leading-out terminals 20. In this state, the movable contact assembly 53 can be considered to be in the first position relative to the support seat 52.

During the process of the movable contact piece 54 separating form the static contact leading-out terminals 20, under the action of the movable core 1240 of the relay, the support seat 52 of the push rod assembly 50 first drives the third magnetizer 60 to move along the axial direction of the push rod 51 away from the first magnetizer 40, meaning the third magnetizer 60 moves before the second magnetizer 55.

As mentioned above, since the magnetic attractive force of the first magnetizer 40 is distributed to the second magnetizer 55 and the third magnetizer 60, there is a portion of the magnetic attractive force between the first magnetizer 40 and the third magnetizer 60.

When the third magnetizer 60 moves before the second magnetizer 55 away from the first magnetizer 40, the separating force only needs to overcome a portion of the magnetic attractive force between the third magnetizer 60 and the first magnetizer 40. As the third magnetizer 60 moves, the magnetic gap between the third magnetizer 60 and the first magnetizer 40 gradually increases, further reducing the magnetic attractive force between them.

It is to be understood that during the process of the third magnetizer 60 moving before the second magnetizer 55, the movable contact assembly 53 can be considered to move from the second position to the first position relative to the support seat 52.

As the third magnetizer 60 moves, the movable contact assembly 53 moves to the first position. Subsequently, the support seat 52 drives the movable contact assembly 53 (including the movable contact piece 54 and the second magnetizer 55) to move away from the first magnetizer 40. Since the third magnetizer 60 has already moved before the second magnetizer 55 away from the first magnetizer 40, and the magnetic gap between the third magnetizer 60 and the first magnetizer 40 gradually increases, the separating force only needs to overcome the magnetic attractive force between the second magnetizer 55 and the first magnetizer 40 to complete the separating between the movable contact piece 54 and the static contact leading-out terminals 20.

Thus, in the relay of the embodiment of the present disclosure, the second magnetizer 55 and the third magnetizer 60 are located at the side of the movable contact piece 54 facing away from the first magnetizer 40. When a short-circuit current flows, anti-short-circuit structures are formed between the first magnetizer 40 and the second magnetizer 55, as well as between the third magnetizer 60 and the first magnetizer 40, effectively increasing the upper limit of anti-short-circuit current-carrying capacity. Moreover, during the process of the movable contact piece 54 separating form with the static contact leading-out terminals 20, the third magnetizer 60 moves before the second magnetizer 55 away from the first magnetizer 40. This staged separating method further facilitates the completion of the separating process. Therefore, the relay of the embodiment of the present disclosure not only ensures anti-short-circuit capability but also meets the requirements for limit separating.

As shown in FIG. 11 and FIG. 12, during the process of the movable contact piece 54 separating form the static contact leading-out terminals 20, and when the movable contact assembly 53 is in the first position relative to the support seat 52, the magnetic gap D22 between the third magnetizer 60 and the first magnetizer 40 is greater than the magnetic gap D21 between the second magnetizer 55 and the first magnetizer 40.

As shown in FIG. 4 and FIG. 5, the relay of the embodiment of the present disclosure further includes a connector 30, which is inserted through the second through-hole 103 and includes a first end 31 and a second end 32. The first end 31 is connected to the contact container 10, and the second end 32 is connected to the first magnetizer 40.

In the relay of the embodiment of the present disclosure, the first magnetizer 40 is connected to the contact container 10 through the connector 30, rather than directly, making the connection process unobstructed and visible. This not only facilitates operation but also ensures the reliability of the connection.

Furthermore, the first through-hole 102 and the second through-hole 103 are both formed in the top wall 111 of the ceramic cover 11, and the first end 31 of the connector 30 is connected to the outer surface of the top wall 111.

On the outer surface of the top wall 111, a first metallization layer 113 is provided around the periphery of the first through-hole 102, and a second metallization layer 114 is provided around the periphery of the second through-hole 103. The static contact leading-out terminals 20 are welded to the top wall 111 through the first metallization layer 113, and the first end 31 of the connector 30 is welded to the top wall 111 through the second metallization layer 114.

Compared to the inner surface of the ceramic cover 11, the outer surface of the top wall 111 is easier to form a welding plane. Additionally, since the top wall 111 of the ceramic cover 11 needs to dispose the static contact leading-out terminals 20, and the static contact leading-out terminals 20 are welded to the top wall 111, a metallization layer is also required around the periphery of the first through-hole 102. Therefore, when processing the first metallization layer 113 for the first through-hole 102, the second metallization layer 114 for the second through-hole 103 is also processed. Thus, by welding the connector 30 to the outer surface of the top wall 111 of the ceramic cover 11, metallization layers need only be processed on the outer surface of the top wall 111, simplifying the processing steps.

The first magnetizer 40 is spaced apart from the inner surface of the top wall 111. By spacing the first magnetizer 40 from the inner surface of the top wall 111, a gap is created between the first magnetizer 40 and the inner surface of the top wall 111. Since the first magnetizer 40 does not directly contact the inner surface of the top wall 111, its presence does not affect the creepage distance of the pair of static contact leading-out terminals 20.

The top wall 111 and the side wall 112 are separate structures and are connected by welding.

It is to be understood that designing the ceramic cover 11 with separate top wall 111 and side wall 112 structures makes it easier to connect the connector 30 to the top wall 111. Of course, the top wall 111 and the side wall 112 may also be connected by adhesive bonding.

Specifically, since the top wall 111 is plate-shaped, the plate structure makes it easier to process the first through-hole 102, the second through-hole 103, the first metallization layer 113, and the second metallization layer 114 on the top wall 111. Furthermore, the plate structure also facilitates the welding of the connector 30 to the top wall 111 and the static contact leading-out terminals 20 to the top wall 111.

Of course, the top wall 111 and the side wall 112 of the ceramic cover 11 may also be an integrated structure.

The connection between the second end 32 of the connector 30 and the first magnetizer 40 can be implemented in various ways, such as welding, riveting, or adhesive bonding.

The first magnetizer 40 includes a plurality of stacked magnetic pieces 41, and the plurality of magnetic pieces 41 are connected to the second end 32 of the connector 30. Each magnetic piece 41 is provided with an opening 411, through which the connector 30 passes and is riveted to the lowermost magnetic piece 41.

Of course, when the first magnetizer 40 includes a plurality of stacked magnetic pieces 41, the opening 411 in the lowermost magnetic piece 41 may be a blind hole, while the openings 411 in the remaining magnetic pieces 41 are through-holes. The connector 30 passes through the openings 411 in the remaining magnetic pieces 41, and the second end of the connector 30 extends into the blind hole of the lowermost magnetic piece 41 and is welded to it.

Additionally, when the first magnetizer 40 is a single piece, it is provided with an opening 411, which may be a through-hole or a blind hole. When the opening 411 is a through-hole, the connector 30 passes through the opening 411 and is riveted to the first magnetizer 40. When the opening 411 is a blind hole, solder may be placed inside the blind hole, and the second end 32 of the connector 30 extends into the blind hole and is welded to the first magnetizer 40.

As an example, when the short-circuit current exceeds 10 kA, the thickness of the first magnetizer 40 needs to be increased to generate a greater magnetic attractive force, ensuring that the magnetic attractive force between the first magnetizer 40 and the second magnetizer 55, as well as between the first magnetizer 40 and the third magnetizer 60, can overcome the repulsive force generated by the short-circuit current and prevent the movable contact piece 54 from bouncing off the static contact leading-out terminals 20. However, a thicker first magnetizer 40 is costly and more difficult to connect to the ceramic cover 11.

In this embodiment, since the first magnetizer 40 is connected to the contact container 10 through the connector 30, the first magnetizer 40 can include a plurality of stacked magnetic pieces 41, and the connector 30 passes through the second through-hole 103 in the plurality of magnetic pieces 41 for connection. By increasing the number of thinner magnetic pieces 41, the overall thickness of the first magnetizer 40 is increased. On one hand, the magnetic pieces 41 are thin and can be made from thin strip material, reducing material costs and facilitating operation. On the other hand, the number of magnetic pieces 41 can be flexibly adjusted according to the magnitude of the short-circuit current.

As shown in FIG. 15, FIG. 15 shows a schematic diagram of the first magnetizer 40 fixedly connected to a fixed frame 70. Of course, in other implementations, the first magnetizer 40 may also be fixedly connected to a fixed frame 70 in addition to be fixedly connected to the ceramic cover 11 as described above. Specifically, the relay further includes a fixed frame 70, which is disposed in the contact chamber 101 and fixedly connected to the yoke plate 13. The first magnetizer 40 is fixedly connected to the fixed frame 70.

It is to be understood that the various embodiments/implementations provided in the present disclosure can be combined without causing contradictions, and examples will not be listed here.

In the disclosed embodiments, the terms “first” “second” and “third” are used for descriptive purposes only and should not be construed as indicating or implying relative importance. The terms “a pair” “a” are used to introduce technical features and should not be construed as limiting the specific quantity of the technical feature unless explicitly stated. The term “plurality” refers to two or more unless explicitly stated. Terms such as “installed” “connected” “fixed” etc., should be understood broadly. For example, “connected” may refer to fixed connections, detachable connections, or integral connections. “Connected” may refer to direct connections or indirect connections through an intermediate medium. For those skilled in the art, the specific meanings of the above terms in the disclosed embodiments can be understood based on specific circumstances.

In the description of the disclosed embodiments, it should be understood that the orientation or positional relationships indicated by terms such as “upper” “lower” “left” “right” “front” and “rear” are based on the orientation or positional relationships shown in the drawings. These terms are used only to facilitate the description of the disclosed embodiments and simplify the description, and do not indicate or imply that the device or unit must have a specific orientation or be constructed and operated in a specific orientation. Therefore, these terms should not be construed as limiting the disclosed embodiments.

In the description of this specification, the terms “one embodiment” “some embodiments” “specific embodiment” etc., refer to the particular features, structures, materials, or characteristics described in connection with that embodiment or example being included in at least one embodiment or example of the disclosed embodiments. In this specification, schematic references to the above terms do not necessarily refer to the same embodiment or instance. Moreover, the described specific features, structures, materials, or characteristics may be combined in any suitable manner in one or more embodiments or examples.

The above is merely a preferred embodiment of the disclosed embodiments and is not intended to limit the scope of the disclosed embodiments. For those skilled in the art, the disclosed embodiments may be subject to various modifications and changes. Any modifications, equivalent substitutions, improvements, etc., made within the spirit and principles of the disclosed embodiments shall be included within the scope of protection of the disclosed embodiments.

It should be understood that the present disclosure does not limit its application to the detailed structure and arrangement of components set forth in this specification. The present disclosure is capable of other embodiments and can be implemented and carried out in various ways. The foregoing variations and modifications fall within the scope of the present disclosure. It should be understood that the disclosure and definition of the present disclosure extend to all alternative combinations of two or more individual features mentioned or apparent in the text and/or drawings. All these different combinations constitute multiple alternative aspects of the present disclosure. The embodiments of the specification illustrate the best mode known for implementing the present disclosure and will enable those skilled in the art to utilize the present disclosure.

1. A relay, comprising:
a contact container having a contact chamber;
a pair of static contact leading-out terminals fixedly disposed relative to the contact container,
a first magnetizer disposed within the contact chamber and fixed relative to the contact container;
a push rod assembly comprising a push rod and a support seat, wherein the push rod is movable relative to the contact container along an axial direction of the push rod, and the support seat is disposed at one axial end of the push rod and extends at least partially into the contact chamber;
a movable contact assembly movable relative to the support seat along the axial direction of the push rod, the movable contact assembly comprising a movable contact piece and a second magnetizer, wherein both ends of the movable contact piece are configured to contact with or separate from the pair of static contact leading-out terminals, and along the axial direction of the push rod, the first magnetizer is located at a side of the movable contact piece facing the static contact leading-out terminals, while the second magnetizer is fixedly disposed to a side of the movable contact piece facing away from the first magnetizer, the second magnetizer is configured to form a first magnetic circuit with the first magnetizer; and
a third magnetizer connected to the support seat and located at the side of the movable contact piece facing away from the first magnetizer, the third magnetizer is movably disposed within the contact chamber along the axial direction of the push rod and configured to form a second magnetic circuit with the first magnetizer.

2-16. (canceled)

17. The relay according to claim 1, wherein the pair of static contact leading-out terminals are connected to the contact container, at least a portion of each of the static contact leading-out terminals is located within the contact chamber.

18. The relay according to claim 1, wherein, during a process of the movable contact piece separating from the static contact leading-out terminals, the third magnetizer moves away from the first magnetizer prior to the second magnetizer.

19. The relay according to claim 1, wherein the movable contact assembly is movable relative to the support seat between a first position closer to the static contact leading-out terminals and a second position farther from the static contact leading-out terminals along the axial direction of the push rod;
the relay further comprises a first elastic member disposed between the support seat and the movable contact assembly, configured to apply an elastic force to the movable contact assembly toward the first position.

20. The relay according to claim 19, wherein in the second position, a magnetic pole surface of the second magnetizer facing the first magnetizer is flush with a magnetic pole surface of the third magnetizer facing the first magnetizer.

21. The relay according to claim 19, wherein during a process of the movable contact piece separating from the static contact leading-out terminals, and when the movable contact assembly is in the first position relative to the support seat, a magnetic gap between the third magnetizer and the first magnetizer is greater than a magnetic gap between the second magnetizer and the first magnetizer.

22. The relay according to claim 19, wherein the movable contact assembly is movably connected to the support seat through a limiting structure, the limiting structure is configured to restrict a movement of the movable contact assembly relative to the support seat between the first position and the second position; the limiting structure comprises:
a limiting groove provided on one of the movable contact assembly and the support seat, the limiting groove extending along the axial direction of the push rod, with a stopping wall provided at one end of the groove wall closer to the static contact leading-out terminals; and
a limiting block provided on another one of the movable contact assembly and the support seat, the limiting block is slidably fitted with the limiting groove, and in the first position, the stopping wall abuts against the limiting block.

23. The relay according to claim 22, wherein in the first position, a first gap exists between the limiting block and a side wall of the limiting groove;
in the second position, a second gap exists between the limiting block and the side wall of the limiting groove;
the first gap is smaller than the second gap.

24. The relay according to claim 22, wherein the limiting block is provided on the second magnetizer, and the limiting groove is provided on the support seat.

25. The relay according to claim 22, wherein the support seat comprises:
a base connected to an end of the push rod along the axial direction of the push rod, with one end of the first elastic member abutting against the base and another end abutting against the movable contact assembly; and
a bracket connected to the base, the limiting groove is provided on the bracket.

26. The relay according to claim 19, wherein the third magnetizer has a through-hole, the first elastic member passes through the through-hole.

27. The relay according to claim 1, wherein a thickness of the second magnetizer is equal to a thickness of the third magnetizer.

28. The relay according to claim 1, wherein the contact container further comprises a pair of first through-holes and a second through-hole, both the first through-holes and the second through-hole are in communication with the contact chamber; the pair of static contact leading-out terminals are respectively passed through the pair of first through-holes;
the relay further comprises a connector passed through the second through-hole, the connector comprises a first end and a second end, the first end is connected to the contact container, and the second end is connected to the first magnetizer.

29. The relay according to claim 27, wherein the contact container comprises:
a yoke plate; and
an insulating cover connected to the yoke plate;
wherein the first through-holes and the second through-hole are provided on the insulating cover, and the first end of the connector is connected to an outer wall surface of the insulating cover.

30. The relay according to claim 28, wherein the insulating cover comprises a ceramic cover and a frame member, the ceramic cover comprises a top wall and a side wall, another end of the side wall is connected to the yoke plate the frame member;
on an outer wall surface of the top wall, a first metallization layer is provided around a periphery of the first through-hole, and a second metallization layer is provided around a periphery of the second through-hole;
the static contact leading-out terminals are welded to the top wall through the first metallization layer, and the first end of the connector is welded to the top wall through the second metallization layer.

31. The relay according to claim 28, wherein the first magnetizer is spaced apart from an inner wall surface of a top wall.

32. The relay according to claim 25, wherein the first magnetizer comprises a plurality of magnetic sheets stacked with each other, and the plurality of magnetic sheets are connected to a second end of the connector.

33. The relay according to claim 1, wherein the contact container comprises:
a yoke plate; and
an insulating cover connected to the yoke plate;
the relay further comprises a fixing frame disposed within the contact chamber and fixedly connected to the yoke plate, the first magnetizer is fixedly connected to the fixing frame.
